(19) United States
(12) Patent Application Publication
(10) Pub. No.: US 2023/0376904 A1
(43) Pub. Date: Nov. 23, 2023

(54) DISTRIBUTED MULTI-STAGE AUTHORIZATION APPROVAL FRAMEWORK

(71) Applicant: Saudi Arabian Oil Company, Dhahran (SA)

(72) Inventors: Taher A. Alwusaibie, Dammam (SA); Hanan Aldossary, Dammam (SA); Reem A. Alothman, Dhahran (SA); Jafar A. Julaih, Al Qatif (SA); Waleed A. Alamri, Dhahran (SA); Sarah A. Saleh, Dammam (SA)

(21) Appl. No.: 17/747,580

(22) Filed: May 18, 2022

(51) Int. Cl. G06Q 10/10

(52) U.S. Cl. CPC G06Q 10/103

(57) ABSTRACT

Systems and methods include a computer-implemented method for multi-stage approval. Approval scenarios are defined that include four stages including a requestor review stage, a requestor management approval stage, an owner approval stage, and a processing stage. A custom proponent code authority is generated for each principal or collection of principals to manage access and roles under their jurisdiction. The custom proponent code authority is generated for each approval scenario through a centralized identity and access management system. A requester review is performed on a request received from a requestor. The requester review is performed using a decentralized approval process. A requestor management approval of the request is performed in the requestor management approval stage. An owner approval is performed in the owner approval stage by an owner associated with owner role names mapped to role suffixes. The owner approval authorizes further processing or access to at least one resource.

### TECHNICAL FIELD

The present disclosure applies to authorization processes.

### BACKGROUND

Large enterprises can have complex authorization requirements for their applications and systems. Conventional systems typically do not provide centralized management and reporting capabilities for identity and access management processes. Furthermore, developing approval for identity and access management for each application is not practical or cost-effective. For this reason, application owners are usually forced to process access requests manually, e.g., using traditional forms, which can delay an employee, such as an approving authority, in achieving their task in a time-efficient way.

### SUMMARY

The present disclosure describes techniques that can be used for providing centralized management and reporting capabilities for identity and access management processes. In some implementations, a computer-implemented method includes the following. Approval scenarios are defined that include four stages including a requestor review stage, a requestor management approval stage, an owner approval stage, and a processing stage. A custom proponent code authority is generated for each principal or collection of principals to manage access and roles under their jurisdiction. The custom proponent code authority is generated for each approval scenario through a centralized identity and access management system. A requester review is performed on a request received from a requestor. The requester review is performed in the requestor review stage using a decentralized approval process. A requestor management approval of the request is performed in the requestor management approval stage. An owner approval is performed in the owner approval stage by an owner associated with owner role names mapped to role suffixes. The owner approval authorizes further processing or access to at least one resource.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. A solution is provided for an optimal model of authorization approvals that can work for all applications and systems in a large enterprise. The improvements and technical advantages of enhanced processes described in the present disclosure include decentralized approval processes that are flexible, optimized, and cost efficient. The present disclosure provides a solution which includes: defining approval scenarios, defining role owners, and using a naming convention for a role which provides flexibility of the role owner and flexibility in requesting based on owners. The framework of the present disclosure includes the following features. The approval framework is enhanced to provide: 1) integration with a corporate human resources system; 2) highly-flexible methods that can accommodate approval scenarios related to identity and access management processes; 3) easy configuration using the abstract scenarios for any processes; 4) reporting capabilities for any application or principals utilizing the framework; 5) design owner role name (user maintenance role) mapped to role suffixes; and 6) flexibility based on a role owner and a requesting owner.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a block diagram showing example stages of an approval scenarios framework, according to some implementations of the present disclosure.

FIG. 2 is a screenshot showing examples of proponent code definitions, according to some implementations of the present disclosure.

FIG. 3 is a screenshot showing an example of owner to maintenance role mapping, according to some implementations of the present disclosure.

FIG. 4 is a screenshot showing an example of a maintenance role to role prefix mapping, according to some implementations of the present disclosure.

FIG. 5 is a screenshot showing examples of role definitions, according to some implementations of the present disclosure.

FIG. 6 is a screenshot showing examples of requests based on owners, according to some implementations of the present disclosure.

FIG. 7 is a screenshot showing examples of users' access, according to some implementations of the present disclosure.

FIG. 8 is a flowchart of an example of a method for implementing an approval process using a centralized identity and access management system, according to some implementations of the present disclosure.

FIG. 9 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for providing centralized management and reporting capabilities for identity and access management processes. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The present disclosure describes custom techniques for accommodating approval scenarios for identity and access management processes in a large enterprise hosting a large number of applications and systems running on different platforms. Use of the techniques can ensure effective management and can reduce the cost of developing a repetitive approval process. A process is provided for effectively employing a decentralized approval model for custom objects and roles with a large number of systems, applications, and authorization objects in a large enterprise. Use of the techniques can optimize (and provide flexible framework for) different approval requirements in an enterprise to extend the capabilities of identity and access management domains in a cybersecurity framework. Optimization can be defined or measured, for example, as completing approval requirements within a time duration that is less than a pre-defined threshold time, or reducing an approval process by a pre-defined percentage of time.

Features of the process can include the at least following: 1) integration with corporate human resources (HR) systems; 2) highly flexible methods that accommodate approval scenarios related to identity and access management processes; 3) a simple and intuitive configuration using the abstract scenarios for any process; 4) reporting capabilities for any application or principals utilizing the framework. Multiple steps can be used in an optimized, distributed, multi-phase authorization approval framework, e.g., as described in the following sections.

### Defining Approval Scenarios

In identity and access management processes, an approval can preferably go through at least one of four stages. The first stage is a requester review. This stage can be mandatory in case the request has been submitted on behalf of a requester. Otherwise, the stage can be skipped if the submitter is the requester.

The second stage is requester management approval. This stage is typically required in all processes and may have different levels for each process, role, user type, or other defined levels (e.g., information system analyst, supervisor, or division head).

The next stage is owner approval. Owner approval can be done, for example, either by organization or security group. For example, each group of users, business roles, variant roles, and admin accounts can be owned by different organizations or can be managed by a specific group. The owner approval stage is important to pass the approval to the right owner(s).

In some cases, manual processing is inevitable. After approval, the request can use a final stage before completion. This stage is usually a processing stage to review documents, perform manual configuration in the system, provide consultation, or perform actions on external or isolated environments.

The process of the multiple stages can include one or more (e.g., two) notifications (such as emails) which are sent to the requester. The first notification can be sent based on submission, e.g., to indicate that a request has been submitted, identifying the requestor and a date/time of the request. Another notification can be sent after the last defined approval stage for the process or after any rejection at any stage including the status of the request.

Each process can have a different approval configuration. For some processes, such as an access request, the approval can be different for each application/role, depending on the application/role approval configuration.

### Defining Proponent Code

In order for an owner approval stage utilizing an owner information security analyst (ISA) group to be successful in highly-optimized process, a custom proponent code is generated for each principal or collection of principals that are mapped to a certain organization or grouped to have a similar type of authority to manage access and roles under their jurisdiction. The proponent code serves as an entry point to any principal that is willing to assume an equal privilege over a collection of roles. The proponent code has an authorization body to approve the acceptance of anyone to join the proponent code access. Upon approving that authority, the principal is mapped to the authorized proponent code(s).

### Design Owner Role Named (User Maintenance Role) Mapped to Roles Suffixes

A custom definition of a role can be designed and created to map the proponent code authority (defined previous) to selected suffixes of defined roles. This role involves the use of custom objects that include a list of roles' prefixes on which the proponent code authority can control acceptance.

### Roles Are Created With Defined Naming Convention and Owners

To allow for the abstraction and simplified use of the system, roles can preferably be created with a defined naming convention, e.g., as defined in a user maintenance role. This will allow the delegation to be done automatically for anyone who has the user maintenance role.

### Role Catalog

Using a flexible model can allow for the same role to have multiple owners in a unique manner. The only requirement is to create a new maintenance role using the existing roles naming convention. The new maintenance role may be owned by a different owner who will be responsible for the new maintenance role.

With the flexibility of role owners, the principal requesting a role may request the role against a specific owner based on defined maintenance roles that are mapped through the naming convention. This flexibility permits individual owners to manage the authorities on decentralized manner.

### Report of Authorities

Proponent code owners can receive a report on a monthly basis, with the report identifying and mapping authorized principals to their owned proponent codes. The reported information provides the owners with the ability to make decisions as to whether principals may continue to assume proponent code authority.

### Renewal of Proponent Code Authority

An annual recertification is required for any principal. During this process, the owner of the proponent code can certify that the principal is qualified to maintain the proponent code authority. In addition, when a principal's organization changes, there can be a requirement to recertify the authority.

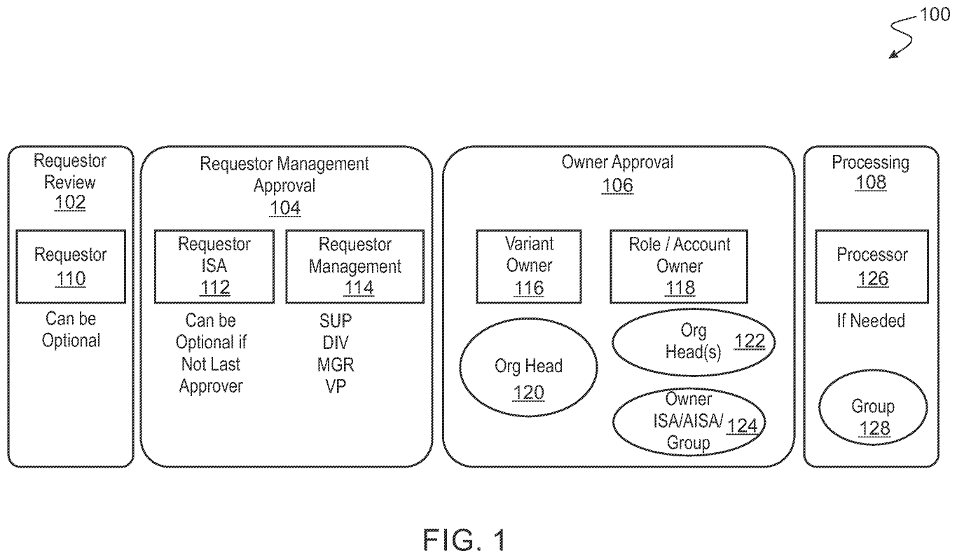

FIG. 1 is a block diagram showing example stages of an approval scenarios framework 100, according to some implementations of the present disclosure. A first stage of the approval scenarios framework is a requester review 102. The stage uses a requester 110 defining the person who is involved in the first stage 102. An approval authority engine can be used to which all requests are routed. In the language of the approval authority engine, the requester, based on the framework, will be the first to receive the request.

A second stage of the approval scenarios framework is a requester management approval stage 104. This stage includes definitions for a requester ISA 112 and requester management 114 (e.g., supervisor, division head, department manager, or vice president (VP)).

A third stage of the approval scenarios framework is an owner approval stage 106, including a variant owner 116. A role/access can have a variant which is an additional selection criteria. For example, a user can request to be a project manager on project A. The owner of Project A, for example, can be set in organization (org) head 120 defining the project's owner who is part of the approval process. The owner approval stage 106 includes a role/account owner 118, and either an organization (org) head 122 or a group 124 (e.g., an owner, an ISA, or an associate information security analyst (AISA).

A fourth stage of the approval scenarios framework 100 is a processing stage 108. Processor 126 defines a processor that is used in this stage of the approval scenarios framework 100 if a processor is needed in this stage. The processer 108 can define a group 128 of individuals that are responsible to process the request.

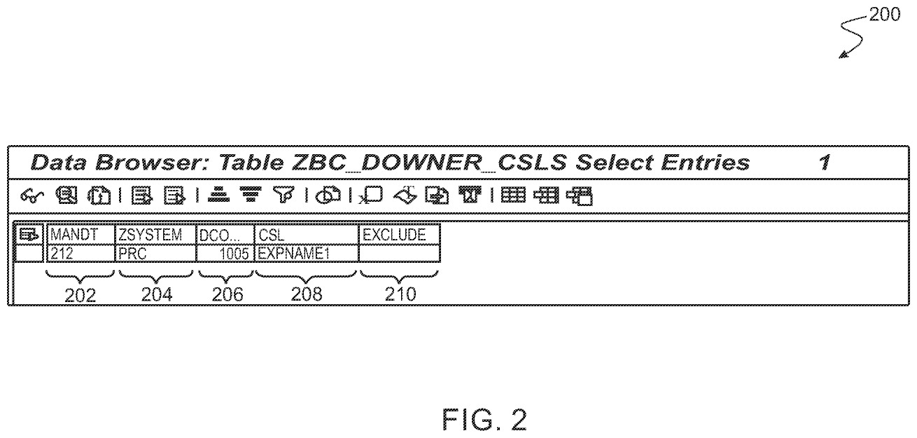

FIG. 2 is a screenshot 200 showing examples of proponent code definitions, according to some implementations of the present disclosure. The screenshot 200 includes a definition identifier (ID) 202, a system 204 associated with the definition, a proponent code value 206, an ISA 208 that owns the proponent code, and any exclusions 210 to this definition.

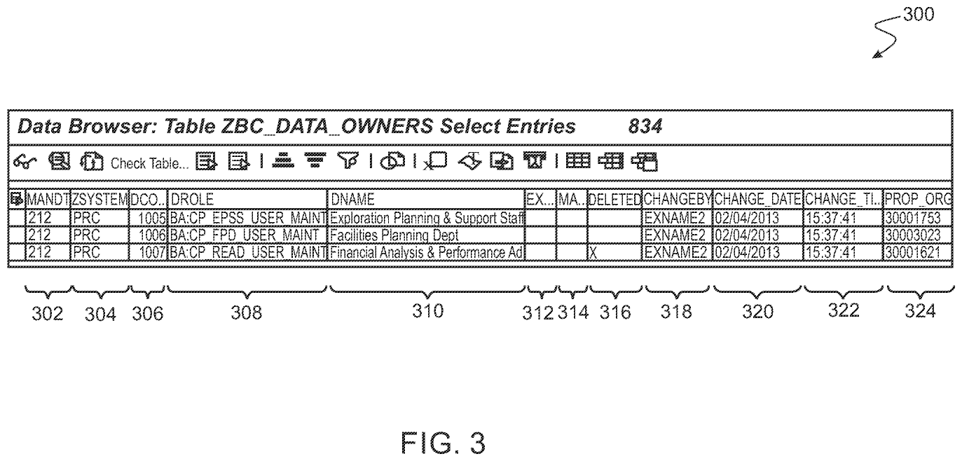

FIG. 3 is a screenshot 300 showing an example of owner to maintenance role mapping, according to some implementations of the present disclosure. The screenshot 300 includes a proponent code definition ID 302, a system 304 associated with the proponent code definition ID 302, a proponent code value 306, an associated user maintenance role 308, a description 310 of the associated user maintenance role, exclusions 312, an indication 314 of whether the definition is manually handled, a deletion indicator 316 indicating whether the definition has been deleted, a change ID 318 indicating who last changed the definition, a change date 320, a change time 322, and an organization code 324 for the mapping.

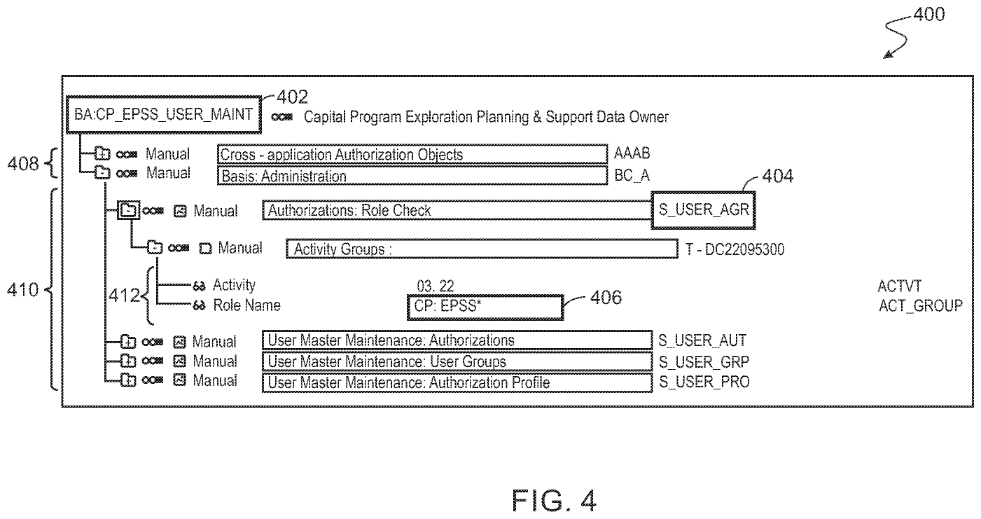

FIG. 4 is a screenshot 400 showing an example of a maintenance role to role prefix mapping, according to some implementations of the present disclosure. The maintenance role to role prefix mapping includes a maintenance role name 402, an authorization role check 404, administrative attributes 408 not being used, a definition 410 indicating how the authorization check happens, a collection 412 of role prefixes, and a role prefix 406.

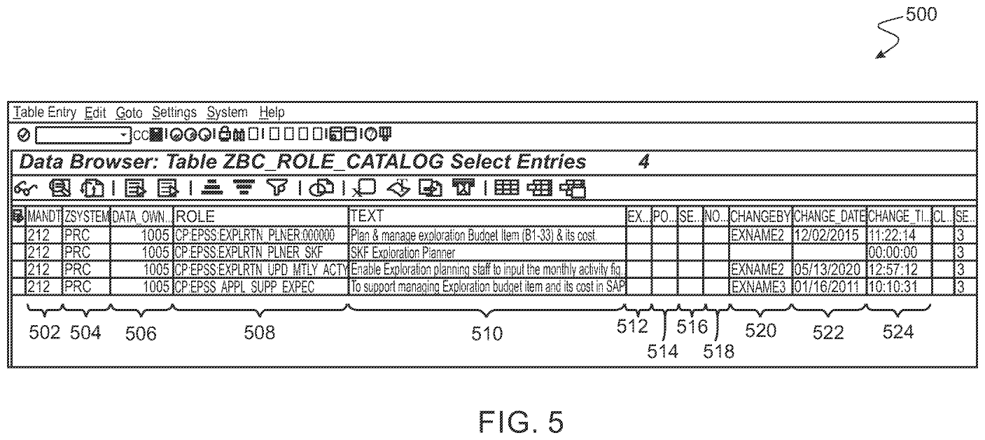

FIG. 5 is a screenshot 500 showing examples of role definitions, according to some implementations of the present disclosure. The screenshot 500 includes a proponent code definition ID 502, a system 504 associated with the role, a proponent owner code 506, a role name 508, a role description 510, exclusions 512, an indicator 514 indicating whether the role is based on the position of the user in the organization, an indicator 516 indicating if the role is sensitive, an indicator 518 indicating if the role is not searchable for users, an identifier 520 identifying who changed the role, a change date 522 indicating when role was changed, and a time of change 524.

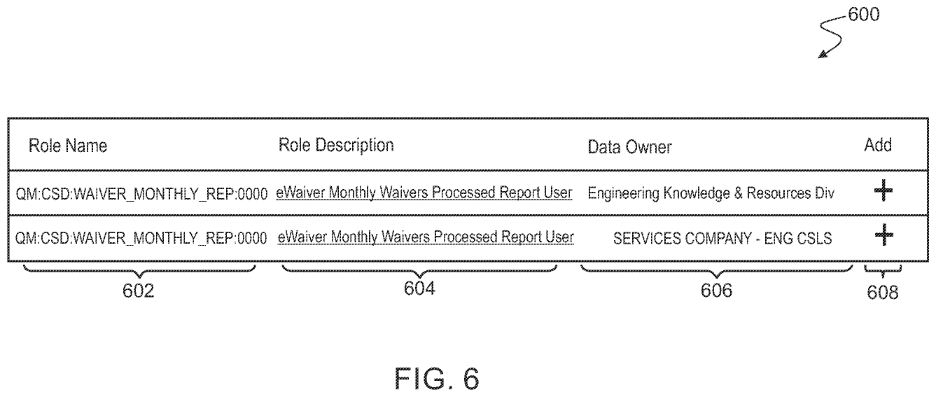

FIG. 6 is a screenshot 600 showing examples of requests based on owners, according to some implementations of the present disclosure. The screen provides an interface that allows users to request roles based on owners. The screenshot 600 includes a role name 602, a role description 604, an organization 606 that owns the role, and an option 608 to request the addition of the role.

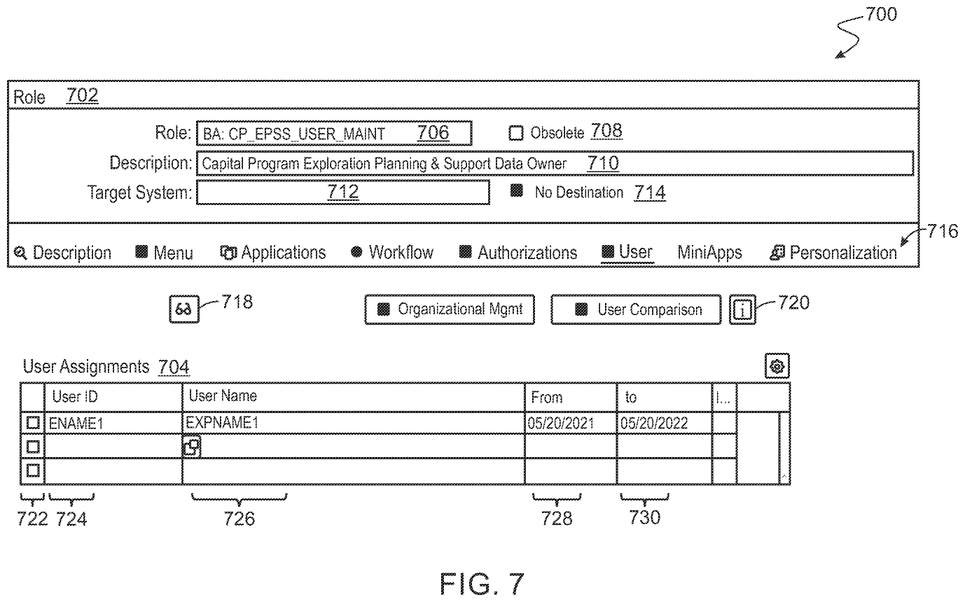

FIG. 7 is a screenshot 700 showing examples of users' access, according to some implementations of the present disclosure. The screenshot 700 includes, in a role section 702, a role name 706, an indicator 708 indicating whether the role is no longer in use, a role description 710 of the role, a system 712 to which the role is associated, a destination systems control 714, tabs 716 for defining other aspects of the role, a details control 718 to list details of the role, and a comparison control 720 to generate a comparison of users access with other roles (720). The screenshot 700 includes, in a user assignment section 704, an option 722 to do action on multiple users at the same time, a user 724 who has access to the role, a user name 726 of the user, a start date 728 of the access, and an end date 730 of the access.

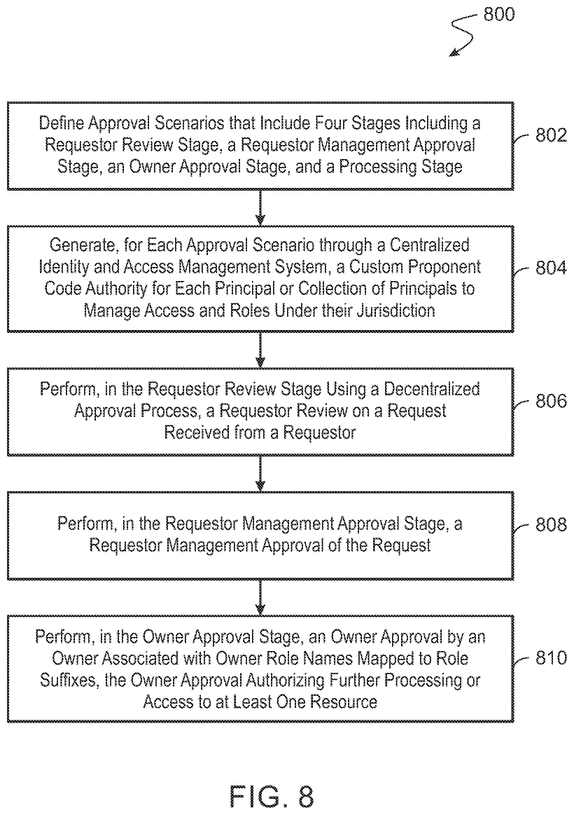

FIG. 8 is a flowchart of an example of a method 800 for implementing an approval process using a centralized identity and access management system, according to some implementations of the present disclosure. For clarity of presentation, the description that follows generally describes method 800 in the context of the other figures in this description. However, it will be understood that method 800 can be performed, for example, by any suitable system, environment, software, and hardware, or a combination of systems, environments, software, and hardware, as appropriate. In some implementations, various steps of method 800 can be run in parallel, in combination, in loops, or in any order.

At 802, approval scenarios are defined that include four stages including a requestor review stage, a requestor management approval stage, an owner approval stage, and a processing stage. The approval scenarios can be defined using the user interfaces described with reference to FIGS. 2-7, for example. From 802, method 800 proceeds to 804.

At 804, a custom proponent code authority is generated for each principal or collection of principals to manage access and roles under their jurisdiction. The custom proponent code authority is generated for each approval scenario through a centralized identity and access management system. In some implementations, the custom proponent code authority is mapped to a certain organization or is grouped to have a similar type of authority. Each role can be defined by a custom role definition designed and created to map the custom proponent code authority to selected suffixes of defined roles. Each role can be associated with custom objects, each object including a list of role prefixes on which the custom proponent code authority can control acceptance. From 804, method 800 proceeds to 806.

At 806, a requester review is performed on a request received from a requestor. The requester review is performed in the requestor review stage using a decentralized approval process. As an example, performing the requester review on the request received from the requestor can include using, in the decentralized approval process, an approval authority engine to which requests are routed. From 806, method 800 proceeds to 808.

At 808, a requestor management approval of the request is performed in the requestor management approval stage. For example, performing the requestor management approval of the request can include obtaining an approval selected from a group consisting of a group leader approval, a division head approval, a department manager approval, and a vice president approval. For example, requestor management approval can span two stages, including using a requester ISA that is decentralized within organizations, and using requester management and varying hierarchies of approval being possible, such as through a group leader, a division head, a department manager, and a VP. The process can be implemented using an approval authority engine where all requests are routed. In the language of approval authority engine, the requester management approval, based on the framework, will receive the request to approve. From 808, method 800 proceeds to 810.

At 810, an owner approval is performed in the owner approval stage by an owner associated with owner role names mapped to role suffixes. The owner approval authorizes further processing or access to at least one resource. For example, the owner can be an organization head, an owner ISA, and an owner AISA. After 810, method 800 can stop.

In some implementations, in addition to (or in combination with) any previously-described features, techniques of the present disclosure can include the following. Outputs of the techniques of the present disclosure can be performed before, during, or in combination with wellbore operations, such as to provide inputs to change the settings or parameters of equipment used for drilling. Examples of wellbore operations include forming/drilling a wellbore, hydraulic fracturing, and producing through the wellbore, to name a few. The wellbore operations can be triggered or controlled, for example, by outputs of the methods of the present disclosure. In some implementations, customized user interfaces can present intermediate or final results of the above described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, drilling parameters (including drill bit speed and direction) or overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period of time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

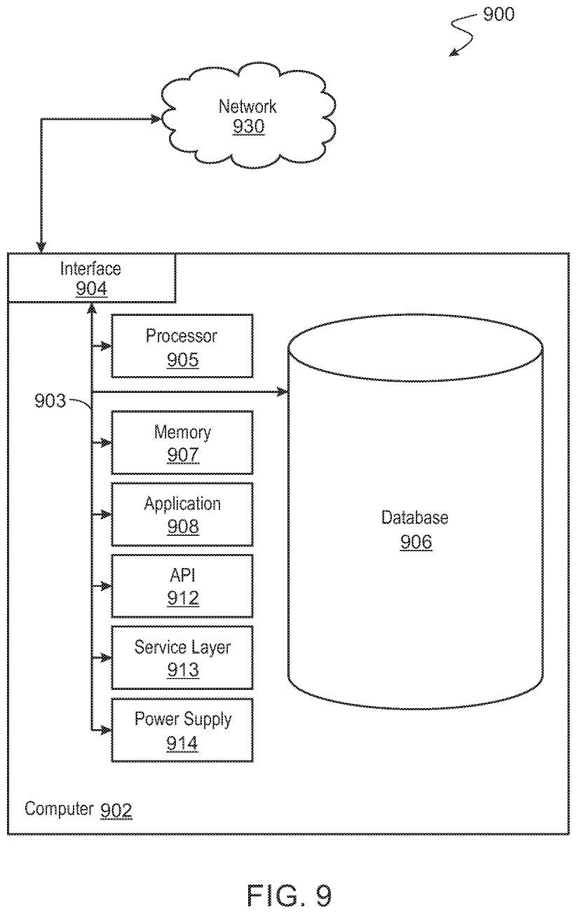

FIG. 9 is a block diagram of an example computer system 900 used to provide computational functionalities associated with described algorithms, methods, functions, processes, flows, and procedures described in the present disclosure, according to some implementations of the present disclosure. The illustrated computer 902 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 902 can include input devices such as keypads, keyboards, and touch screens that can accept user information. Also, the computer 902 can include output devices that can convey information associated with the operation of the computer 902. The information can include digital data, visual data, audio information, or a combination of information. The information can be presented in a graphical user interface (UI) (or GUI).

The computer 902 can serve in a role as a client, a network component, a server, a database, a persistency, or components of a computer system for performing the subject matter described in the present disclosure. The illustrated computer 902 is communicably coupled with a network 930. In some implementations, one or more components of the computer 902 can be configured to operate within different environments, including cloud-computing-based environments, local environments, global environments, and combinations of environments.

At a top level, the computer 902 is an electronic computing device operable to receive, transmit, process, store, and manage data and information associated with the described subject matter. According to some implementations, the computer 902 can also include, or be communicably coupled with, an application server, an email server, a web server, a caching server, a streaming data server, or a combination of servers.

The computer 902 can receive requests over network 930 from a client application (for example, executing on another computer 902). The computer 902 can respond to the received requests by processing the received requests using software applications. Requests can also be sent to the computer 902 from internal users (for example, from a command console), external (or third) parties, automated applications, entities, individuals, systems, and computers.

Each of the components of the computer 902 can communicate using a system bus 903. In some implementations, any or all of the components of the computer 902, including hardware or software components, can interface with each other or the interface 904 (or a combination of both) over the system bus 903. Interfaces can use an application programming interface (API) 912, a service layer 913, or a combination of the API 912 and service layer 913. The API 912 can include specifications for routines, data structures, and object classes. The API 912 can be either computer-language independent or dependent. The API 912 can refer to a complete interface, a single function, or a set of APIs.

The service layer 913 can provide software services to the computer 902 and other components (whether illustrated or not) that are communicably coupled to the computer 902. The functionality of the computer 902 can be accessible for all service consumers using this service layer. Software services, such as those provided by the service layer 913, can provide reusable, defined functionalities through a defined interface. For example, the interface can be software written in JAVA, C++, or a language providing data in extensible markup language (XML) format. While illustrated as an integrated component of the computer 902, in alternative implementations, the API 912 or the service layer 913 can be stand-alone components in relation to other components of the computer 902 and other components communicably coupled to the computer 902. Moreover, any or all parts of the API 912 or the service layer 913 can be implemented as child or sub-modules of another software module, enterprise application, or hardware module without departing from the scope of the present disclosure.

The computer 902 includes an interface 904. Although illustrated as a single interface 904 in FIG. 9, two or more interfaces 904 can be used according to particular needs, desires, or particular implementations of the computer 902 and the described functionality. The interface 904 can be used by the computer 902 for communicating with other systems that are connected to the network 930 (whether illustrated or not) in a distributed environment. Generally, the interface 904 can include, or be implemented using, logic encoded in software or hardware (or a combination of software and hardware) operable to communicate with the network 930. More specifically, the interface 904 can include software supporting one or more communication protocols associated with communications. As such, the network 930 or the interface's hardware can be operable to communicate physical signals within and outside of the illustrated computer 902.

The computer 902 includes a processor 905. Although illustrated as a single processor 905 in FIG. 9, two or more processors 905 can be used according to particular needs, desires, or particular implementations of the computer 902 and the described functionality. Generally, the processor 905 can execute instructions and can manipulate data to perform the operations of the computer 902, including operations using algorithms, methods, functions, processes, flows, and procedures as described in the present disclosure.

The computer 902 also includes a database 906 that can hold data for the computer 902 and other components connected to the network 930 (whether illustrated or not). For example, database 906 can be an in-memory, conventional, or a database storing data consistent with the present disclosure. In some implementations, database 906 can be a combination of two or more different database types (for example, hybrid in-memory and conventional databases) according to particular needs, desires, or particular implementations of the computer 902 and the described functionality. Although illustrated as a single database 906 in FIG. 9, two or more databases (of the same, different, or combination of types) can be used according to particular needs, desires, or particular implementations of the computer 902 and the described functionality. While database 906 is illustrated as an internal component of the computer 902, in alternative implementations, database 906 can be external to the computer 902.

The computer 902 also includes a memory 907 that can hold data for the computer 902 or a combination of components connected to the network 930 (whether illustrated or not). Memory 907 can store any data consistent with the present disclosure. In some implementations, memory 907 can be a combination of two or more different types of memory (for example, a combination of semiconductor and magnetic storage) according to particular needs, desires, or particular implementations of the computer 902 and the described functionality. Although illustrated as a single memory 907 in FIG. 9, two or more memories 907 (of the same, different, or combination of types) can be used according to particular needs, desires, or particular implementations of the computer 902 and the described functionality. While memory 907 is illustrated as an internal component of the computer 902, in alternative implementations, memory 907 can be external to the computer 902.

The application 908 can be an algorithmic software engine providing functionality according to particular needs, desires, or particular implementations of the computer 902 and the described functionality. For example, application 908 can serve as one or more components, modules, or applications. Further, although illustrated as a single application 908, the application 908 can be implemented as multiple applications 908 on the computer 902. In addition, although illustrated as internal to the computer 902, in alternative implementations, the application 908 can be external to the computer 902.

The computer 902 can also include a power supply 914. The power supply 914 can include a rechargeable or non-rechargeable battery that can be configured to be either user-or non-user-replaceable. In some implementations, the power supply 914 can include power-conversion and management circuits, including recharging, standby, and power management functionalities. In some implementations, the power supply 914 can include a power plug to allow the computer 902 to be plugged into a wall socket or a power source to, for example, power the computer 902 or recharge a rechargeable battery.

There can be any number of computers 902 associated with, or external to, a computer system containing computer 902, with each computer 902 communicating over network 930. Further, the terms “client,” “user,” and other appropriate terminology can be used interchangeably, as appropriate, without departing from the scope of the present disclosure. Moreover, the present disclosure contemplates that many users can use one computer 902 and one user can use multiple computers 902.

Described implementations of the subject matter can include one or more features, alone or in combination.

For example, in a first implementation, a computer-implemented method includes the following. Approval scenarios are defined that include four stages including a requestor review stage, a requestor management approval stage, an owner approval stage, and a processing stage. A custom proponent code authority is generated for each principal or collection of principals to manage access and roles under their jurisdiction. The custom proponent code authority is generated for each approval scenario through a centralized identity and access management system. A requester review is performed on a request received from a requestor. The requester review is performed in the requestor review stage using a decentralized approval process. A requestor management approval of the request is performed in the requestor management approval stage. An owner approval is performed in the owner approval stage by an owner associated with owner role names mapped to role suffixes. The owner approval authorizes further processing or access to at least one resource.

The foregoing and other described implementations can each, optionally, include one or more of the following features:

A first feature, combinable with any of the following features, the method further including mapping the custom proponent code authority to a certain organization or grouped to have a similar type of authority.

A second feature, combinable with any of the previous or following features, where performing the requester review on the request received from the requestor includes using, in the decentralized approval process, an approval authority engine to which requests are routed.

A third feature, combinable with any of the previous or following features, where performing the requestor management approval of the request includes obtaining an approval selected from a group consisting of a group leader approval, a division head approval, a department manager approval, and a vice president approval.

A fourth feature, combinable with any of the previous or following features, where the owner is selected from a group consisting of an organization head, an owner information security analyst (ISA), and an owner associate information security analyst (AISA).

A fifth feature, combinable with any of the previous or following features, where each role is defined by a custom role definition designed and created to map the custom proponent code authority to selected suffixes of defined roles.

A sixth feature, combinable with any of the previous or following features, where each role is associated with custom objects, each object including a list of role prefixes on which the custom proponent code authority can control acceptance.

In a second implementation, a non-transitory, computer-readable medium stores one or more instructions executable by a computer system to perform operations including the following. Approval scenarios are defined that include four stages including a requestor review stage, a requestor management approval stage, an owner approval stage, and a processing stage. A custom proponent code authority is generated for each principal or collection of principals to manage access and roles under their jurisdiction. The custom proponent code authority is generated for each approval scenario through a centralized identity and access management system. A requester review is performed on a request received from a requestor. The requester review is performed in the requestor review stage using a decentralized approval process. A requestor management approval of the request is performed in the requestor management approval stage. An owner approval is performed in the owner approval stage by an owner associated with owner role names mapped to role suffixes. The owner approval authorizes further processing or access to at least one resource.

The foregoing and other described implementations can each, optionally, include one or more of the following features:

A first feature, combinable with any of the following features, the operations further including mapping the custom proponent code authority to a certain organization or grouped to have a similar type of authority.

A second feature, combinable with any of the previous or following features, where performing the requester review on the request received from the requestor includes using, in the decentralized approval process, an approval authority engine to which requests are routed.

A third feature, combinable with any of the previous or following features, where performing the requestor management approval of the request includes obtaining an approval selected from a group consisting of a group leader approval, a division head approval, a department manager approval, and a vice president approval.

A fourth feature, combinable with any of the previous or following features, where the owner is selected from a group consisting of an organization head, an owner information security analyst (ISA), and an owner associate information security analyst (AISA).

A fifth feature, combinable with any of the previous or following features, where each role is defined by a custom role definition designed and created to map the custom proponent code authority to selected suffixes of defined roles.

A sixth feature, combinable with any of the previous or following features, where each role is associated with custom objects, each object including a list of role prefixes on which the custom proponent code authority can control acceptance.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. Approval scenarios are defined that include four stages including a requestor review stage, a requestor management approval stage, an owner approval stage, and a processing stage. A custom proponent code authority is generated for each principal or collection of principals to manage access and roles under their jurisdiction. The custom proponent code authority is generated for each approval scenario through a centralized identity and access management system. A requester review is performed on a request received from a requestor. The requester review is performed in the requestor review stage using a decentralized approval process. A requestor management approval of the request is performed in the requestor management approval stage. An owner approval is performed in the owner approval stage by an owner associated with owner role names mapped to role suffixes. The owner approval authorizes further processing or access to at least one resource.

The foregoing and other described implementations can each, optionally, include one or more of the following features:

A first feature, combinable with any of the following features, the operations further including mapping the custom proponent code authority to a certain organization or grouped to have a similar type of authority.

A second feature, combinable with any of the previous or following features, where performing the requester review on the request received from the requestor includes using, in the decentralized approval process, an approval authority engine to which requests are routed.

A third feature, combinable with any of the previous or following features, where performing the requestor management approval of the request includes obtaining an approval selected from a group consisting of a group leader approval, a division head approval, a department manager approval, and a vice president approval.

A fourth feature, combinable with any of the previous or following features, where the owner is selected from a group consisting of an organization head, an owner information security analyst (ISA), and an owner associate information security analyst (AISA).

A fifth feature, combinable with any of the previous or following features, where each role is defined by a custom role definition designed and created to map the custom proponent code authority to selected suffixes of defined roles.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware-or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at the application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
defining approval scenarios that include four stages including a requestor review stage, a requestor management approval stage, an owner approval stage, and a processing stage;
generating, for each approval scenario through a centralized identity and access management system, a custom proponent code authority for each principal or collection of principals to manage access and roles under their jurisdiction;
performing, in the requestor review stage using a decentralized approval process, a requester review on a request received from a requestor;
performing, in the requestor management approval stage, a requestor management approval of the request; and
performing, in the owner approval stage, an owner approval by an owner associated with owner role names mapped to role suffixes, the owner approval authorizing further processing or access to at least one resource.

2. The computer-implemented method of claim 1, further comprising:
mapping the custom proponent code authority to a certain organization or grouped to have a similar type of authority.

3. The computer-implemented method of claim 1, wherein performing the requester review on the request received from the requestor includes using, in the decentralized approval process, an approval authority engine to which requests are routed.

4. The computer-implemented method of claim 1, wherein performing the requestor management approval of the request includes obtaining an approval selected from a group consisting of a group leader approval, a division head approval, a department manager approval, and a vice president approval.

5. The computer-implemented method of claim 1, wherein the owner is selected from a group consisting of an organization head, an owner information security analyst (ISA), and an owner associate information security analyst (AISA).

6. The computer-implemented method of claim 1, wherein each role is defined by a custom role definition designed and created to map the custom proponent code authority to selected suffixes of defined roles.

7. The computer-implemented method of claim 1, wherein each role is associated with custom objects, each object including a list of role prefixes on which the custom proponent code authority can control acceptance.

8. A non-transitory, computer-readable medium storing one or more instructions executable by a computer system to perform operations comprising:
defining approval scenarios that include four stages including a requestor review stage, a requestor management approval stage, an owner approval stage, and a processing stage;
generating, for each approval scenario through a centralized identity and access management system, a custom proponent code authority for each principal or collection of principals to manage access and roles under their jurisdiction;
performing, in the requestor review stage using a decentralized approval process, a requester review on a request received from a requestor;
performing, in the requestor management approval stage, a requestor management approval of the request; and
performing, in the owner approval stage, an owner approval by an owner associated with owner role names mapped to role suffixes, the owner approval authorizing further processing or access to at least one resource.

9. The non-transitory, computer-readable medium of claim 8, the operations further comprising:
mapping the custom proponent code authority to a certain organization or grouped to have a similar type of authority.

10. The non-transitory, computer-readable medium of claim 8, wherein performing the requester review on the request received from the requestor includes using, in the decentralized approval process, an approval authority engine to which requests are routed.

11. The non-transitory, computer-readable medium of claim 8, wherein performing the requestor management approval of the request includes obtaining an approval selected from a group consisting of a group leader approval, a division head approval, a department manager approval, and a vice president approval.

12. The non-transitory, computer-readable medium of claim 8, wherein the owner is selected from a group consisting of an organization head, an owner information security analyst (ISA), and an owner associate information security analyst (AISA).

13. The non-transitory, computer-readable medium of claim 8, wherein each role is defined by a custom role definition designed and created to map the custom proponent code authority to selected suffixes of defined roles.

14. The non-transitory, computer-readable medium of claim 8, wherein each role is associated with custom objects, each object including a list of role prefixes on which the custom proponent code authority can control acceptance.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
that include four stages including a requestor review stage, a requestor management approval stage, an owner approval stage, and a processing stage;
generating, for each approval scenario through a centralized identity and access management system, a custom proponent code authority for each principal or collection of principals to manage access and roles under their jurisdiction;
performing, in the requestor review stage using a decentralized approval process, a requester review on a request received from a requestor;
performing, in the requestor management approval stage, a requestor management approval of the request; and
performing, in the owner approval stage, an owner approval by an owner associated with owner role names mapped to role suffixes, the owner approval authorizing further processing or access to at least one resource.

16. The computer-implemented system of claim 15, the operations further comprising:
mapping the custom proponent code authority to a certain organization or grouped to have a similar type of authority.

17. The computer-implemented system of claim 15, wherein performing the requester review on the request received from the requestor includes using, in the decentralized approval process, an approval authority engine to which requests are routed.

18. The computer-implemented system of claim 15, wherein performing the requestor management approval of the request includes obtaining an approval selected from a group consisting of a group leader approval, a division head approval, a department manager approval, and a vice president approval.

19. The computer-implemented system of claim 15, wherein the owner is selected from a group consisting of an organization head, an owner information security analyst (ISA), and an owner associate information security analyst (AISA).

20. The computer-implemented system of claim 15, wherein each role is defined by a custom role definition designed and created to map the custom proponent code authority to selected suffixes of defined roles.
